(19) United States
(12) Patent Application Publication
(10) Pub. No.: US 2014/0203552 A1
(43) Pub. Date: Jul. 24, 2014

(54) RESTRAINING SYSTEMS FOR BELLED PIPE

(71) Applicants: Samuel Guzowski, San Jose (CR); Luis Pablo Ulloa, Cartago (CR); Hernan Bastos, Cartago (CR); Miguel A. Gomez, San Jose (CR)

(72) Inventors: Samuel Guzowski, San Jose (CR); Luis Pablo Ulloa, Cartago (CR); Hernan Bastos, Cartago (CR); Miguel A. Gomez, San Jose (CR)

(21) Appl. No.: 13/748,481

(22) Filed: Jan. 23, 2013

(51) Int. Cl. F16L 17/025

(52) U.S. Cl. CPC F16L 17/025
USPC 285/349

(57) ABSTRACT

A restraining system for connecting a belled end of a female pipe to a spigot end of a male pipe is disclosed. The system includes a ring-shaped casing having circumferential grooves separated by an abutment surface. One or more restraining rings or members are disposed in the grooves so as to contact both the casing and the outer surfaces of the male and female pipes. The one or more restraining rings restrain the pipes from moving away from each other when the system is pressurized.

### BACKGROUND OF THE INVENTION

1. Field of the Invention

The present invention relates to the joining of pipes and specifically to restraining systems for connecting the belled end of a length of pipe to the spigot end of a length of pipe or fitting and methods for manufacturing the same.

2. Description of the Related Art

Pipelines for conveying fluids can be made from a number of different materials, including plastic materials, such as polyethylene or polyvinyl chloride (PVC), and metals, such as steel, brass and aluminum. Pipes formed from plastic materials are used in a variety of industries. Each length of such pipe typically has a belled female end and a spigot male end. In forming a joint between sections of pipe, the spigot or male pipe end is inserted within the female or socket pipe end. The joints between sections of pipe are sealed, typically with a gasket. For example, an annular, elastomeric ring or gasket is typically seated within a groove formed in the belled end of the pipe. As the spigot is inserted within the socket, the gasket provides the major seal capacity for the joint.

In addition, some type of restraining system is required in order to prevent separation of the sections of pipe due to fluid pressures and environmental effects. Early attempts to ensure the integrity of pipe joints used under demanding conditions was to provide local reinforcement by means of a heavier wall thickness or a reinforcing sleeve in the seal region. These external restraining systems were expensive and required time-consuming installation procedures and often contributed to the complexity and expense of the manufacturing operation. Even in applications where pressure conditions are not as extreme, as in sewer pipe and irrigation pipe, it is desirable to properly position the seal and insure its integrity.

Development of restraining systems using gaskets initially emulated systems used in the ductile iron industry to join sections of iron pipe. For example, systems for joining ductile iron fittings to PVC pipe, such as those shown in U.S. Pat. Nos. 6,945,570 and 7,125,054, use bolted flanges along with the seal.

Some systems have been developed for connecting sections of PVC pipe and for connecting fittings to PVC pipe. These PVC pipe systems have relied mainly on the “Rieber Joint,” which was developed in the early 1970's by Rieber & Son of Bergen, Norway, to seal the connections. The Rieber Joint has an elastomeric gasket inserted into a groove on the inside of the belled end of a piece of the PVC pipe as the female end is being formed. External elements are then added to restrain the pipe after the joint is assembled. For example, in U.S. Pat. No. 7,284,310 the restraint mechanism, which is internal, is a ring-shaped gripping insert having gripping teeth. The insert is placed inside the belled end. When the spigot end is inserted and the joint is pressurized, the gripping insert is activated.

While such a system may be an improvement over simply using the Rieber Joint alone, it has several disadvantages, including the possibility of failure due to the complexity of the combined insert and seal. The insert and seal must both be placed in the belled end and then are simultaneously seated during joint assembly. Further, a post assembly visual inspection is not possible due to the inserts internal location. Upon assembly, the entire restraint mechanism is hidden from view. Thus, a need exists for a restraining system for bell and spigot pipes and fittings that provides ease of assembly and the ability for inspection while still maintaining the integrity of the seal.

### SUMMARY OF THE INVENTION

An aspect of the present invention involves a restraining system for securing a female pipe to a mating male pipe. In certain embodiments, the pipes are plastic. The female pipe has a distal surface. The system includes a ring-shaped casing having an interior surface and an exterior surface. The interior surface has a plurality of circumferential grooves separated by an abutment surface. The abutment surface is configured to contact the distal surface of the female pipe at least when the casing is slid over the female pipe. The system further includes a first restraining ring having a first diameter and being configured to be disposed in one of the plurality of grooves so as to contact both the casing and the female pipe and a second restraining ring having a second diameter and being configured to be disposed in another one of the plurality of grooves so as to contact the casing and the male pipe, the second diameter being less than the first diameter. The system further includes a sealing ring disposed between portions of the male and female pipes.

Another aspect is a restraining system for securing a female plastic pipe to a mating male plastic pipe. The female plastic pipe has a distal surface. The system comprises a ring-shaped casing having an interior surface and an exterior surface. The interior surface has at least one circumferential groove and an abutment surface. At least a portion of the interior surface is disposed so as to be adhered to an outer surface of the female plastic pipe. The abutment surface is configured to contact the distal surface of the female plastic pipe at least when the casing is slid over the female plastic pipe. The system further includes a restraining member configured to be disposed in the at least one circumferential groove so as to contact both the casing and the male plastic pipe.

Another aspect is a restraining system for permitting relative movement of male and female plastic pipes in a longitudinal direction towards each other during assembly while inhibiting relative movement of the male and female plastic pipes in a direction away from each other to prevent separation. The system includes a ring-shaped casing having an interior surface, the interior surface having a plurality of grooves, and a first restraining member having a first inner diameter and being configured to be disposed in one of the plurality of grooves so as to contact both the inner surface of the casing and the female plastic pipe. The system further includes a second restraining member having a second inner diameter and being configured to be disposed in another one of the plurality of grooves so as to contact the inner surface of the casing and the male plastic pipe. The second inner diameter is less than the first inner diameter.

Another aspect is a restraining system for securing a female plastic pipe to a mating male plastic pipe. The female plastic pipe has an outer surface with one or more slots and a distal surface. The system includes a ring-shaped casing having an interior surface and an exterior surface, the interior surface having at least one circumferential groove, one or more ridges, and an abutment surface disposed therebetween. The one or more ridges are disposed so as to engage with the one or more slots in the female plastic pipe and the abutment surface is configured to contact the distal surface of the female plastic pipe at least when the casing is slid over the female plastic pipe. The system further includes a restraining member configured to be disposed in the at least one circumferential groove so as to contact both the casing and the male plastic pipe.

The systems and methods of the invention have several aspects and features, no single one of which is solely responsible for all of its desirable attributes. Without limiting the scope of the invention as expressed by the claims, its more prominent aspects have been discussed briefly above. Further aspects and features will also be understood from the description below. Additionally, various aspects and features of the system can be practiced apart from each other. For example, while several of the above-noted aspects of the invention involve a restraint system that includes at least one restraining ring, the restraining ring itself can form a separate aspect of the present invention.

### BRIEF DESCRIPTION OF THE DRAWINGS

These and other features, aspects and advantages of the present invention will now be described in connection with preferred embodiments of the invention, in reference to the accompanying drawings. The illustrated embodiments, however, are merely examples and are not intended to limit the invention. The following are brief descriptions of the drawings.

FIG. 1 is a perspective view, broken away, of male and female pipe sections about to form a pipe coupling, the belled end of the female pipe section showing a seal in place within a mating groove provided therein;

FIG. 2 is a perspective view of a restraining system according to a preferred embodiment of the present invention which restrains the pipe coupling formed by the male and female pipe sections from FIG. 1;

FIG. 3 is an exploded cross-sectional view of the pipe coupling and restraining system from FIG. 2 showing a casing and associated restraining members;

FIG. 4A is a perspective view of the casing from FIG. 3;

FIG. 4B is a cross-section view of the casing from FIG. 4A;

FIG. 5A is a perspective view of one of the restraining members from FIG. 3;

FIG. 5B is a cross-section view of the restraining member from FIG. 5A;

FIG. 6A is a perspective view of the other restraining member from FIG. 3;

FIG. 6B is a cross-section view of the restraining member from FIG. 6A;

FIG. 7A is a perspective view of the seal from FIG. 3;

FIG. 7B is a cross-section of the seal from FIG. 7A;

FIG. 8 is a perspective view of an alternate embodiment of a restraining member that includes gripping sections separated by elastomeric sections;

FIG. 9A is a cross-section view of the assembled joint from FIG. 2 showing both the spigot end of the male pipe and the belled end of the female pipe inside the casing with the restraining members restraining separation of the spigot end from the female pipe;

FIG. 9B shows the movement of the belled end of the female pipe into the casing;

FIG. 9C shows movement of the spigot end of the male pipe into the casing and the belled end of the female pipe;

FIG. 9D shows the engagement of the restraining members with outer surfaces of the male and female pipes causing compression of the casing around the joint, and the restraining of the male pipe inside the female pipe;

FIG. 10A is a perspective view of an alternate embodiment of the casing, which includes one or more O-rings for preventing the entrance of foreign material and external water into the joint;

FIG. 10B is a cross-section view of the casing from FIG. 10A restraining a joint and including a plurality of inner channels for receiving the one or more O-rings;

FIG. 11A is a perspective view of an alternate embodiment of the casing, which includes two types of restraining member;

FIG. 11B is a plan view of one of the two types of restraining member from FIG. 11A which is in the form of a toothed ring;

FIG. 11C is a perspective view of the casing from FIG. 11A with toothed rings disposed in a plurality of channels on one end of the casing;

FIG. 11D is a cross-section view of an assembled joint that includes the casing from FIG. 11C;

FIG. 12A is a perspective view of an alternate embodiment of the casing, which includes a plurality of channels for receiving restraining members in the form of toothed rings on both ends of the casing;

FIG. 12B is a cross-section view of an assembled joint that includes the casing from FIG. 12A;

FIG. 13A is a perspective view of an alternate embodiment of a casing that includes another type of restraining member;

FIG. 13B is a cross-section view of the casing and restraining members from FIG. 13A;

FIG. 14A is a perspective view of an alternate embodiment of the casing, which has been adhered to the outer surface of the female pipe and includes a restraining member for gripping against the outer surface of the male pipe;

FIG. 14B is a cross-section view of an assembled joint that includes the casing from FIG. 14A.

FIG. 14C is a cross-section view of the assembled joint from FIG. 14B with a structural wrap disposed around the outer circumference of the assembled joint.

FIG. 15 is a perspective view, broken away, of male and female pipe sections about to form a pipe coupling utilizing an alternate embodiment of the casing where the female pipe section includes one or more slots for engaging with one or more ridges on the casing;

FIG. 16 is a perspective view of the casing from FIG. 15;

FIG. 17 is a perspective view of the casing from FIG. 16 with the one or more ridges on one end of the casing for engaging with the one or more slots on the female pipe section; and

FIG. 18 is a cross-section view of an assembled joint that includes the casing from FIG. 17.

### DETAILED DESCRIPTION OF CERTAIN EMBODIMENTS

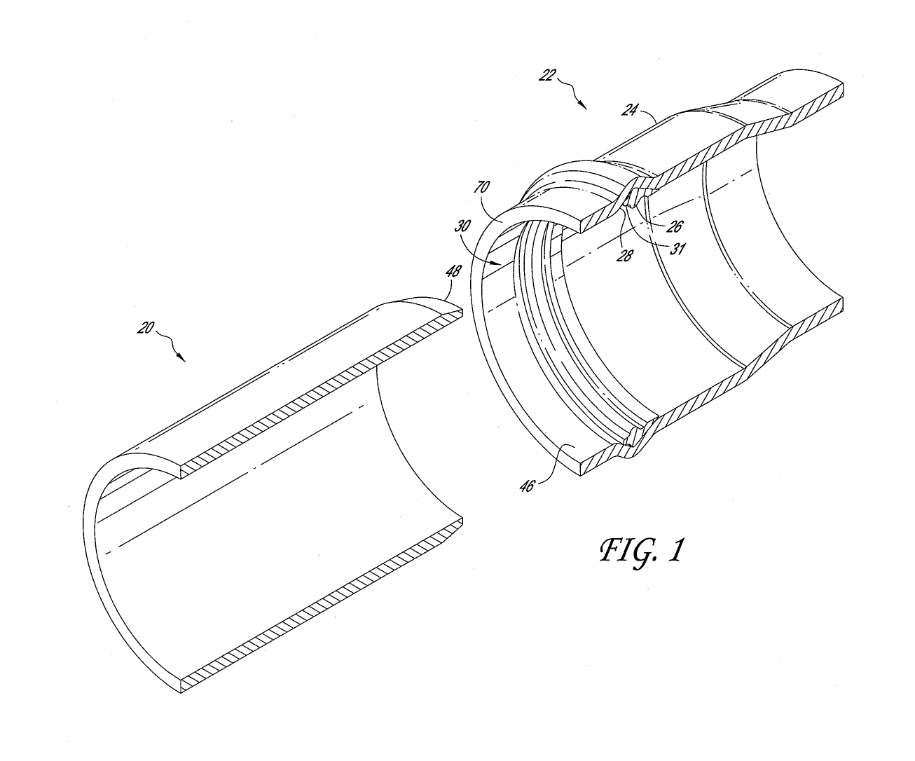

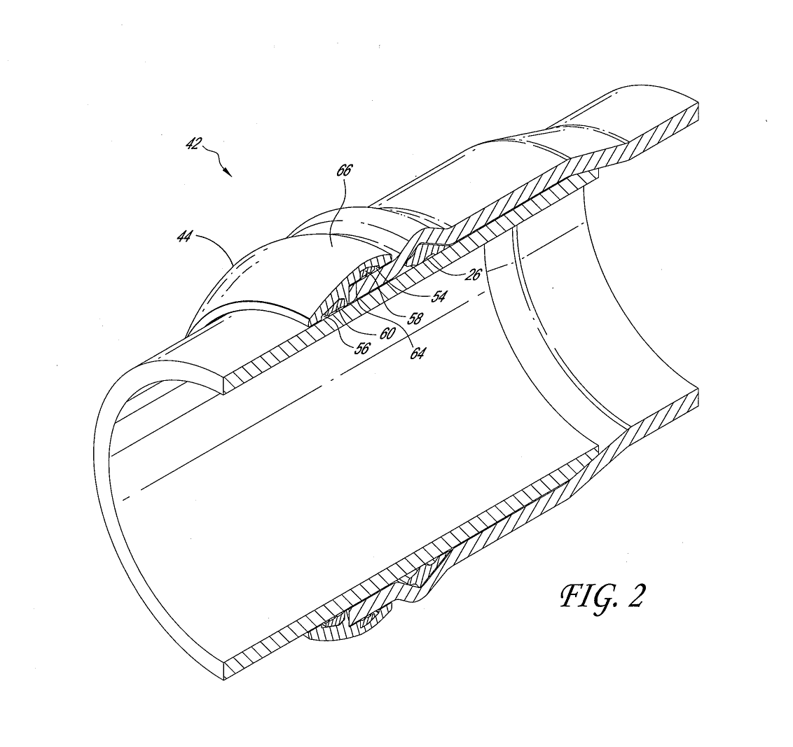

FIG. 1 is a perspective view, partly broken away, of male and female pipe sections 20, 22 about to form a pipe coupling, the belled end 24 of the female pipe section 22 showing a sealing ring 26 in place within a mating groove 28 provided therein. FIG. 2 is a perspective view of a restraining system 42 according to a preferred embodiment of the present invention which restrains the pipe coupling formed by the male and female pipe sections 20, 22 from FIG. 1.

The restraining system 42 illustrated in FIG. 2 includes a casing 44 fabricated for use with the male and female pipes 20, 22 in combination with an integrated or other type of sealing ring 26, which will seal the joint. The seal 26 is preferably placed in the groove 28 prior to assembly of the male 20 and female pipes 22. Of course the seal 26 need not be placed within the groove 28 prior to assembly and instead may be placed within the groove 28 during assembly of the joint.

In certain embodiments, the inner diameter of the lip 46 of the belled end 24 has a smooth finish thereon. A leading portion of the outer diameter of the male pipe 20 has a chamfered surface 48 formed thereon for facilitating passage of the male pipe 20 through the seal 26 and the female pipe 22.

The casing 44 can be made from any of a number of materials, including steel with a corrosion-protection coating, stainless steel, brass, aluminum, polyvinyl chloride (PVC) or other rigid plastic material, or a composite material. The casing 44 comprises an exterior surface 66 and an interior surface 64. The interior surface 64 of the casing 44 comprises one or more grooves 54, 56. The grooves 54, 56 extend along at least a portion of the inner circumference of the casing 44. In certain embodiments, one or more of the grooves 54, 56 extend about the entire inner circumference of the casing 44. In embodiments which have a plurality of grooves 54, 56, each groove 54, 56 need not have the same circumferential length. Further, a groove 54, 56 need not have the same radial clocking as another groove 54, 56. For example, a first groove 54 can extend in a clockwise direction between 12 o'clock and 6 o'clock while a second groove 56 extends in a clockwise direction between 6 o'clock and 12 o'clock. In this way, the first groove 54 need not overlap the second groove 56. Alternatively, the first and second grooves 54, 56 at least partially overlap or entirely overlap.

The grooves 54, 56 are sized and shaped to receive one or more restraining members or rings 58, 60. Each of the grooves 54, 56 desirably is sufficiently wide to allow the restraining member 58, 60 to have a range of motion that allows the casing 44 to apply a sufficient compressive load to the pipe joint that will maintain the integrity of the seal 26. The restraining member 58, 60 may have the same circumferential length as the corresponding groove 54, 56 or a length that is less than the length of the corresponding groove. Thus, the restraining member 58, 60 need not extend about the entire inner circumference of the casing 44 or for the entire length of the corresponding groove 54, 56. In the illustrated embodiment, the grooves 54, 56 and the restraining members 58, 60 extend about the entire circumference of the casing 44.

Each restraining member 58, 60 may have a unitary structure or comprise one or more segments. Further the one or more segments may or may not be joined at their ends to define the restraining member 58, 60. As described below, in certain embodiments the segments of the restraining members 58, 60 are not homogenous and comprise different material. For example, alternating joined segments can comprise a metal and a rubber.

In certain embodiments, the one or more restraining members 58, 60 and the casing 44 are manufactured as a unitary structure. Alternatively, the one or more restraining members 58, 60 and the casing 44 are separately manufactured and assembled. For example, the one or more restraining members 58, 60 can be placed in the one or more grooves 54, 56 in the casing 44 to form the restraining system 42. Depending on, for example, pipe geometry, materials, operating pressures, and loading, it may be preferred to allow at least relative movement of at least a portion of the one or more restraining members 58, 60 relative to the casing 44. In the embodiment illustrated in FIG. 2, the restraining members 58, 60 are separate structures assembled with the casing 44 which allows each of the restraining members 58, 60 to move relative to the casing 44. For example, the restraining members 58, 60 may slide in a longitudinal direction across the outer surfaces of the male and female pipes 20, 22 to wedge or lock between the casing 44 and the adjacent pipe 20, 22. Once wedged, the compression of the restraining members 58, 60 around the male and female pipes 20, 22 by the casing 44 prevents further movement of the male pipe 20 away from the female pipe 22 that would degrade the function of the seal 26. In embodiments where the restraining members 58, 60 are integral to the casing 44, at least portions of the restraining member 58, 60 may move with respect to the casing 44 to wedge or lock the casing 44 on the pipe. For example, a distal portion of the restraining member 58, 60 my move or flex with respect to the casing 44 during joint assembly to wedge or lock the casing 44 on the pipe.

In the illustrated embodiment, restraining member 58 is received within groove 54 and restraining member 60 is received within groove 56. The restraining member 58 is disposed between the casing 44 and the female pipe 22 to grip the female pipe 22. The restraining member 60 is disposed between the casing 44 and the male pipe 20 to grip the male pipe 20.

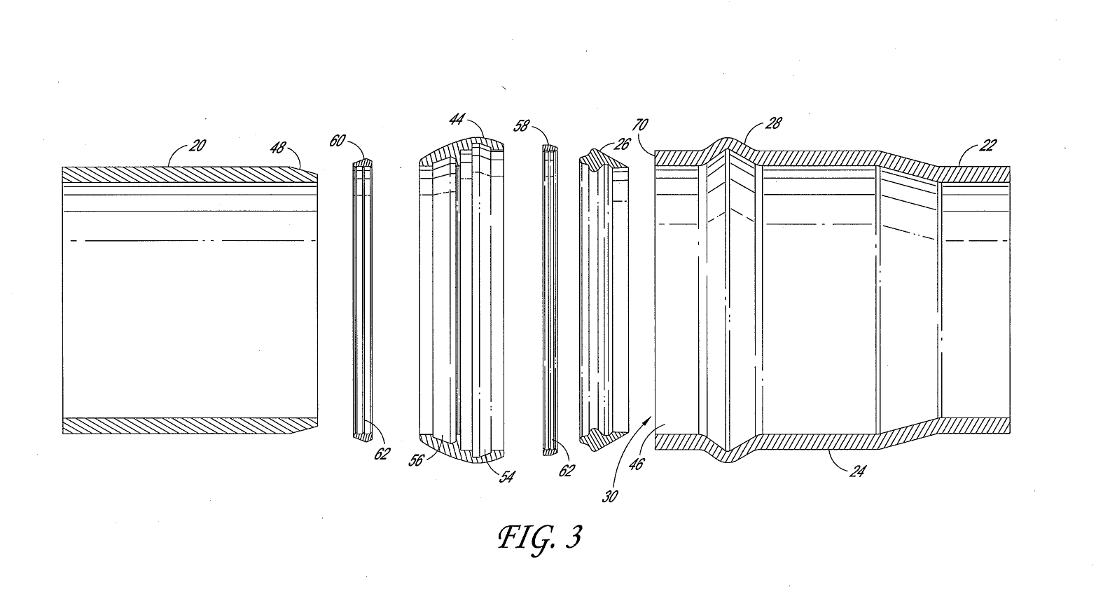

FIG. 3 is an exploded cross-sectional view of the pipe coupling and restraining system from FIG. 2 showing the casing 44 and associated restraining members 58, 60. Each restraining member 58, 60 may have one or more teeth or projections 62 for contacting one or more adjacent surfaces. Exemplary adjacent surfaces may be on the casing 44, the male pipe 20, the female pipe 22, and/or an adjacent restraining member. For example, the one or more teeth or projections 62 may extend from an end of the restraining member 58 in the groove 54 and contact a surface on an end of an adjacent restraining member 58 in the same groove 54.

The one or more teeth or projections 62 advantageously increase the surface friction between the restraining member 58, 60 and the adjacent surface. This increase in surface friction may be in one or more directions. For example, the one or more teeth or projections 62 can extend in a direction that is normal to the adjacent surface or canted or angled with respect to the adjacent surface. For embodiments where the one or more teeth or projections 62 extend normal to the adjacent surface, the increase in surface friction may be generally equal in both directions. Thus, the degree of resistance to sliding the restraining member 58, 60 may be the same in either longitudinal direction along the outer surface of the pipe. In embodiments where the one or more teeth or projections 62 are canted or angled, the increase in surface friction may be greater in one direction. Thus, the degree of resistance to sliding the restraining member 58, 60 may be greater in a direction towards the center of casing 44 than in a direction away from the center of the casing 44. Other factors can change the degree of resistance including the degree of compression applied by the casing 44 to the restraining member 58, 60 as well as the distribution of the compressive force across the surface of the restraining member 58, 60.

In certain embodiments, the teeth or projections 62 are angled on the restraining member 58, 60 so as to contact the outer surface of the male and female pipes 20, 22 and inhibit movement of the restraining member 58, 60 in one direction more than in another direction. For example, in certain embodiments the teeth or projections 62 are biased so as to inhibit movement in a direction towards the center of the casing 44. In this way, the restraining member 58, 60 is allowed to slide in the groove 54, 56 and across the outer surface of the male or female pipe 20, 22 in a direction away from the center of the casing 44 during assembly until the restraining member 58, 60 is wedged or locked between the casing 44 and the adjacent male or female pipe 20, 22. Once wedged or locked between the casing 44 and the adjacent male or female pipe 20, 22, the one or more teeth or projections 62 will inhibit movement of the restraining member 58, 60 towards the center of the casing 44 so as to maintain compression of the pipe joint by the casing 44.

The one or more teeth or projections 62 may be arranged in rows, grids, or any other shape on the restraining member 58, 60 and may have a fixed or variable spacing between adjacent teeth and/or between adjacent rows of teeth. The rows of teeth 62 thus provide multiple locations which can bite into or lock onto the male or female pipe 20, 22. One or more of the projections or teeth 62 can be canted so as to inhibit rotation of the restraining member 58, 60 within the groove 54, 56.

The one or more teeth or projections 62 desirably are positioned between the restraining member 58, 60 and the outer surface of the male or female pipe 20, 22 and are canted or angled so as to inhibit movement of the restraining member 58, 60 towards the center of the casing 44 while allowing the restraining member 58, 60 to move away from the center of the casing 44. In the illustrated embodiment, a plurality of angled rows of teeth 62 extend from a surface of each restraining member 58, 60 towards the adjacent male or female pipe 20, 22.

The one or more teeth or projections 62 desirably have sufficient thickness or bulk so as to resist nominal applied forces, i.e. not break when moved towards the wedge or lock position. Also, the portions of the one or more teeth or projections 62 that contact the male or female pipe 20, 22 are of sufficient lateral or transverse dimension to inhibit movement of the female or male pipe 20, 22 in the longitudinal direction relative to the restraining member 58, 60. That is, the one or more teeth or projections 62 contact the male or female pipe 20, 22 by a sufficient amount to engage with the male or female pipe 20, 22.

In the illustrated embodiment, each of the one or more teeth or projections 62 has generally a linear shape about the inner circumference of the restraining member 58, 60. Thus, the one or more teeth or projections 62 generally form a series of linear teeth along a section of each restraining member 58, 60. The one or more teeth or projections 62, however, can be configured in a wide variety of other shapes, including, but not limited to, rectangular, semi-circular, square, curvilinear, triangular or the like. Thus, one or more teeth or projections 62 may be linear, as illustrated, or curved or curvilinear to suit a particular application, so as to inhibit relative migration of the male or female pipe 20, 22 in the longitudinal direction.

In certain embodiments, the distal ends of the one or more teeth or projections 62 taper back toward the corresponding groove 54, 56. This taper can generally follow an arcuate path that corresponds to a surface of the male or female pipe 20, 22. The one or more teeth or projections 62, however, can extend about the entire arc of the corresponding groove 54, 56 or the one or more teeth or projections 62 can extend for less than the entire arc.

The one or more teeth or projections 62 can be advantageously sized and configured to cooperate with a corresponding recess(es) on the outer surface of the male or female pipes 20, 22.

In certain embodiments, the one or more teeth or projections 62 fit into the recess(es) and engage the sides of the recess(es) so as to inhibit longitudinal movement of the male or female pipe 20, 22 relative to the restraining member 58, 60. In the illustrated embodiment, the male and female pipes 20, 22 have a smooth outer surface; however, any number of annular grooves can be disposed in the outer surfaces of the male and female pipes 20, 22.

As mentioned above, rows of the one or more teeth or projections 62 are formed on the inner circumference of the restraining member 58, 60 in the illustrated embodiment. Each restraining member 58, 60 may have a different number of rows of the one or more teeth or projections 62.

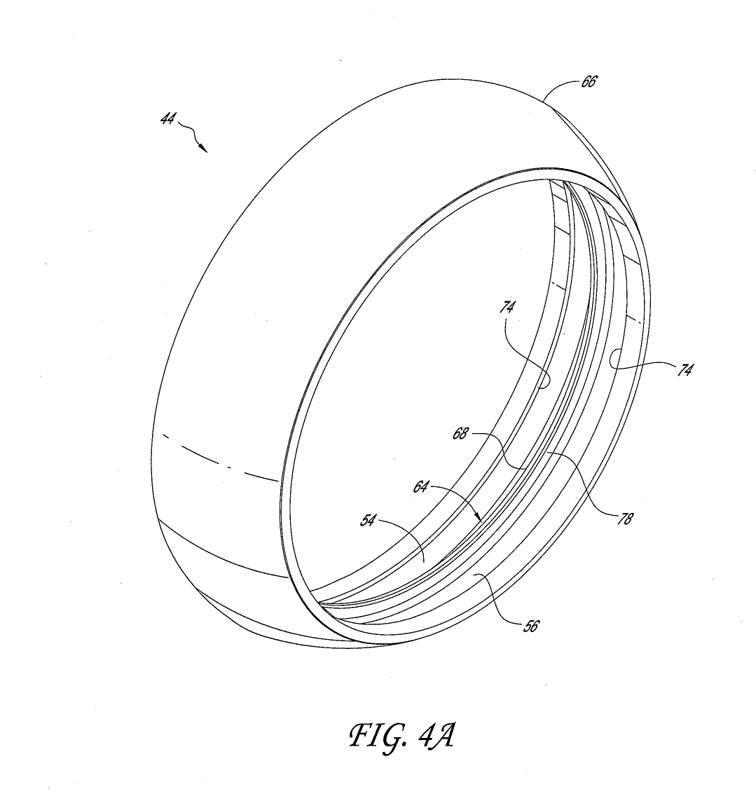

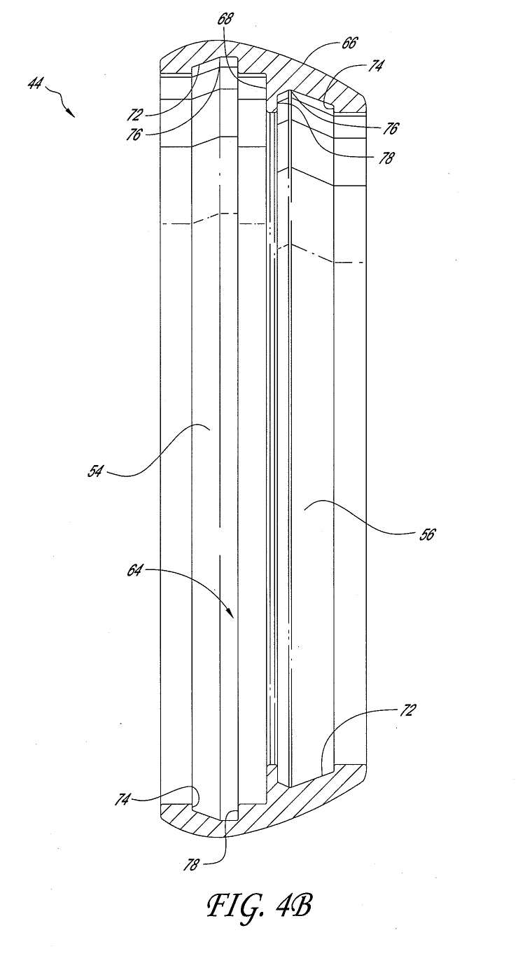

FIG. 4A is a perspective view of the casing 44 from FIG. 3 with the restraining members 58, 60 removed from the grooves 54, 56. The casing 44 and the restraining members 58, 60 form one embodiment of the restraining system 42. FIG. 4B is a cross-section view of the casing 44 from FIG. 4A. The casing 44 will be installed around the outside of the male and female pipes 20, 22 at the location of the joint in combination with the restraining members 58, 60. The seal 26 is also located between the male and female pipes 20, 22 and performs the sealing function. The seal 26 is preferably disposed in the groove 28 formed in the female pipe 22.

As shown in the embodiments illustrated in FIG. 4A, the casing 44 is formed from a single piece typically made from a rigid material. For example, the material can be plain steel with corrosion-protection coating, stainless steel, brass, aluminum, or a material such as ceramic. The casing 44 has a ring-shape with an interior surface 64 and an exterior surface 66. The interior surface 64 includes one or more circumferential grooves 54, 56. One or more restraining members 58, 60 and/or seal members may be disposed in the grooves 54, 56.

Disposed between the grooves 54, 56 on the interior surface 64 is an abutment surface 68. The abutment surface 68 facilitates installation of the casing 44. For example, the abutment surface 68 is configured to contact the lip 46 of the female pipe 22 at least when the casing 44 is slid over the socket end 30 of the female pipe 22. In certain embodiments, a distal surface 70 on the lip 46 contacts the abutment surface 68. The abutment surface 68 prevents the casing 44 from sliding too far along the female pipe 22 during assembly and locates the grooves 54, 56 around the outer surfaces of the male and female pipes 20, 22, respectively. The abutment surface 68 need not extend about the entire circumference of the joint and may instead be in the form of one or more segments or points spaced about the interior surface 64 of the casing 44. Further, even in embodiments where the abutment surface 68 extends about the entire interior surface 64 of the casing 44, the abutment surface 68 need not have the same profile for the entire inner circumference. For example, the profile of the abutment surface 68 may have a wavy shape so that the female pipe 22 only contacts the abutment surface 68 at one or more points along the abutment surface 68.

The casing 44 includes one or more grooves 54, 56 in its inner circumference. In certain embodiments, the casing 44 includes additional grooves for one or more seals, such as O-rings or the like. The O-rings inhibit external contaminants from entering between the casing 44 and the outer surfaces of the male and female pipes 20, 22.

The shape of the grooves 54, 56 includes a stop 74 which continues towards a generally ramp shaped portion 72. The ramp 72 slopes away from the outer surfaces of the male and female pipes 20, 22 in a direction along the longitudinal axis towards the abutment surface 68. The ramp 72 has a complementary shape to the outer surface of the restraining members 58, 60. In this way the restraining members 58, 60 can slide along the ramp 72. Preferably the one or more teeth or projections 62 prevent the restraining members 58, 60 from sliding in both longitudinal directions.

As the restraining members 58, 60 slide across the ramps 72 along the longitudinal axis in a direction away from the abutment surface 68, any gaps between the casing 44 and the restraining members 58, 60 will decrease until the restraining members 58, 60 are in full contact with the grooves 54, 56 and the outer surfaces of the male and female pipes 20, 22. Further movement of the restraining members 58, 60 across the ramps 72 causes the casing 44 to tighten around the outer surface of the male and female pipes 20, 22 and inhibit relative movement between the male and female pipes 20, 22. For example, the restraining members 58, 60 can slide towards the abutment surface 68 during assembly of the joint. The sloping ramp 72 of the one or more grooves 54, 56 extends upwardly before reaching a peak 76 and then gradually slopes downwardly until it terminates in an internal shoulder 78. The abutment surface 68 is disposed between the internal shoulders 78 of the grooves 54, 56.

The internal shoulder 78 of the groove 54 faces in the same direction as the abutment surface 68. The internal shoulder 78 of the groove 56 is arranged to face in the opposite direction to the abutment surface 68. The stop 74 is formed as a circumferential flange adjacent the outer edges of the casing 44 and prevents the restraining members 58, 60 from overly compressing the outer surfaces of the male and female pipes 20, 22 as the pipe joint is being assembled.

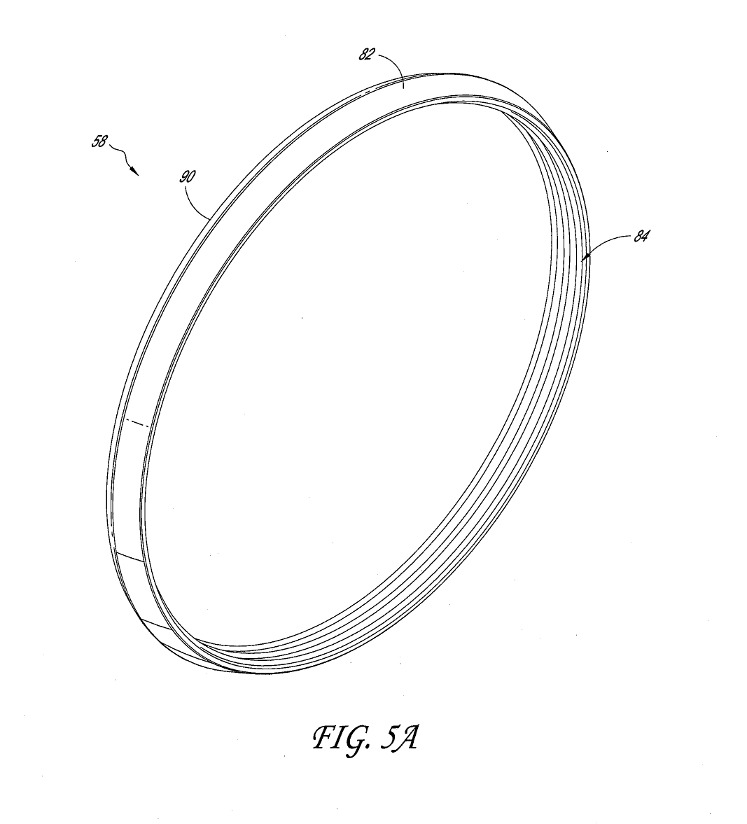

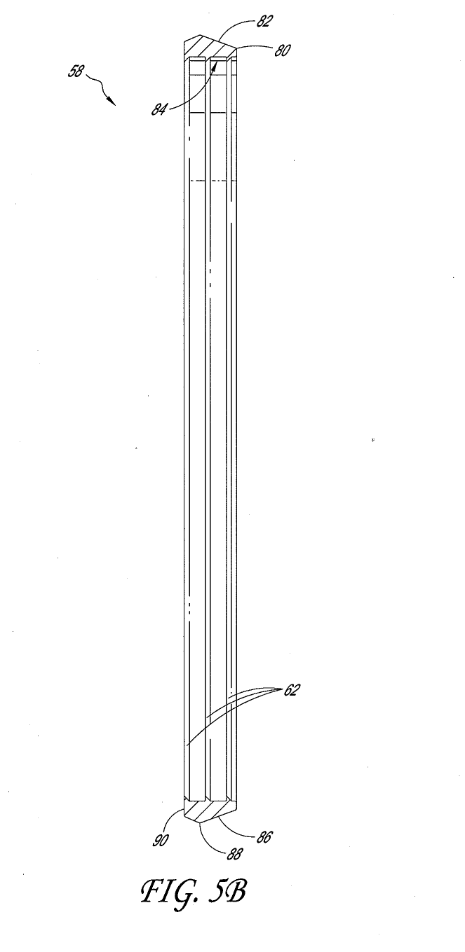

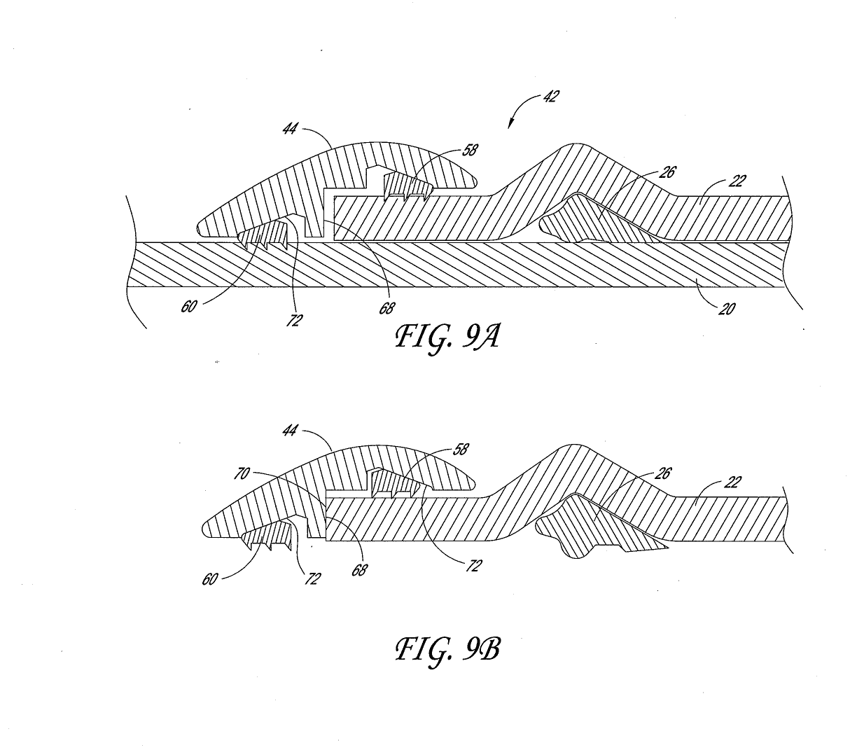

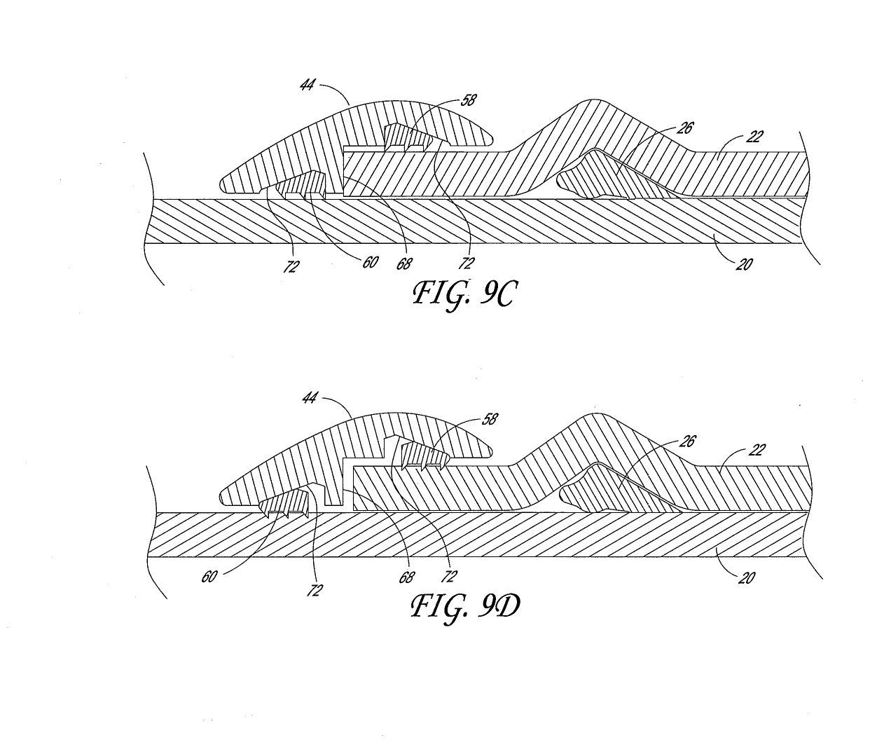

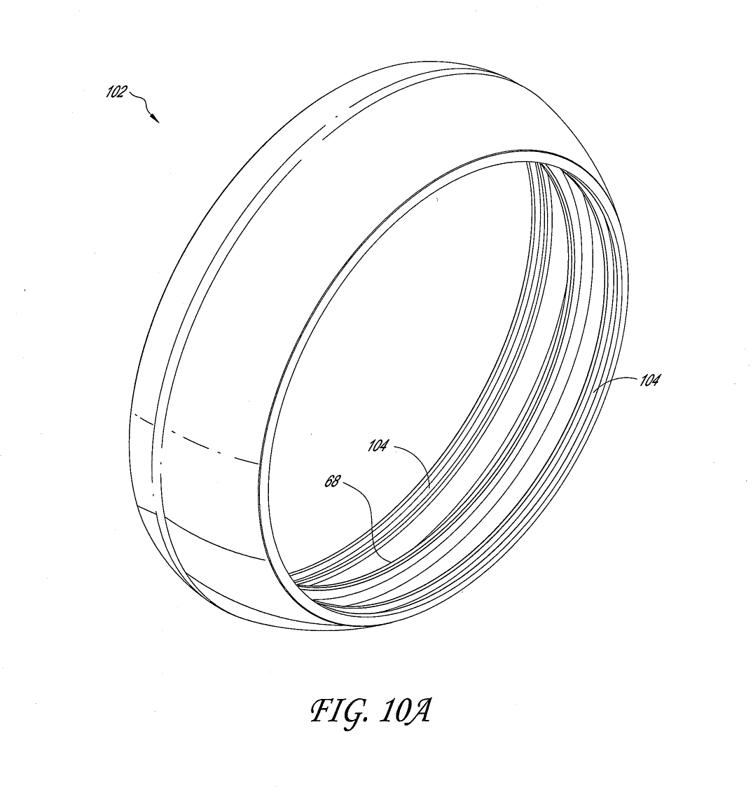

FIG. 5A is a perspective view of the restraining member 58 from FIG. 3. FIG. 5B is a cross-section view of the restraining member 58 from FIG. 5A. The restraining member 58 is received in a complimentary fashion within the groove 54 contained within the interior surface 64 of the casing 44. As shown in FIG. 9A, a tip region 80 of the restraining member 58 contacts the stop 74 on the inner surface 64 of the casing 44 to prevent the restraining member 58 from sliding out of the groove 54 and thereby assist in retaining the restraining member 58 within the casing 44. The restraining member 58 has an exterior surface 82 and an interior surface 84. The interior surface 84 has the one or more teeth or projections 62. In the illustrated embodiment shown in FIG. 5B, the restraining member 58 has three rows of teeth 62. The rows of teeth 62 on the restraining member 58 are arranged for engaging selected points on the exterior surface of the female pipe 22 while the rows of teeth 62 on the restraining member 60 are arranged for engaging selected points on the outer surface of the exterior surface of the male pipe 20. The restraining member 58 exterior surface 82 has a sloping profile 86 which contacts the upwardly sloping ramp 72 of the casing 44. Contact with the outer surface of the female pipe 22 causes the restraining member 58 to ride along the ramp 72 at an angle while the one or more teeth or projections 62 on the restraining member 58 interior surface 84 engage the exterior surface of the female pipe 22.

The one or more teeth or projections 62 on the interior surface 84 of the restraining member 58 can be of equal height as measured from the interior surface 84 or can vary in length and can be arranged in either a uniform or non-uniform pattern about the inner circumference of the restraining member 58. In the illustrated embodiment, the rows of teeth 62 have a uniform height. In certain embodiments, the rows of teeth 62 have a slightly greater height than other rows of teeth 62. The one or more teeth or projections 62 are angled away from a radial direction at an angle of less than 90 degree. In certain embodiments, the angle is 60 degrees or 45 degrees. As explained above, the angle of the one or more teeth or projections 62 inhibits movement in one longitudinal direction.

The exterior surface 82 of the restraining member 58 extends from the tip region 80 across the sloping profile 86 and reaches peak 88. The exterior surface 82 continues in a downward direction and terminates at base 90.

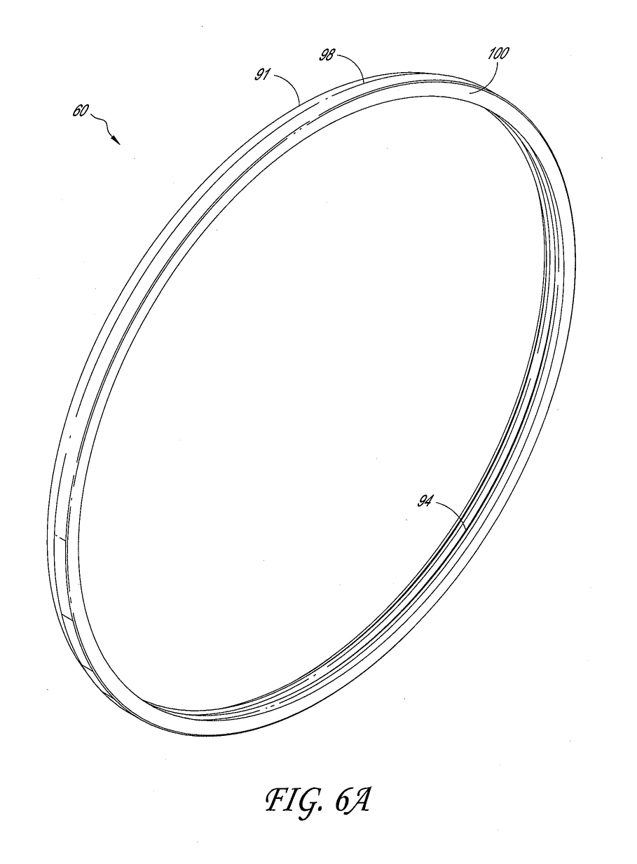

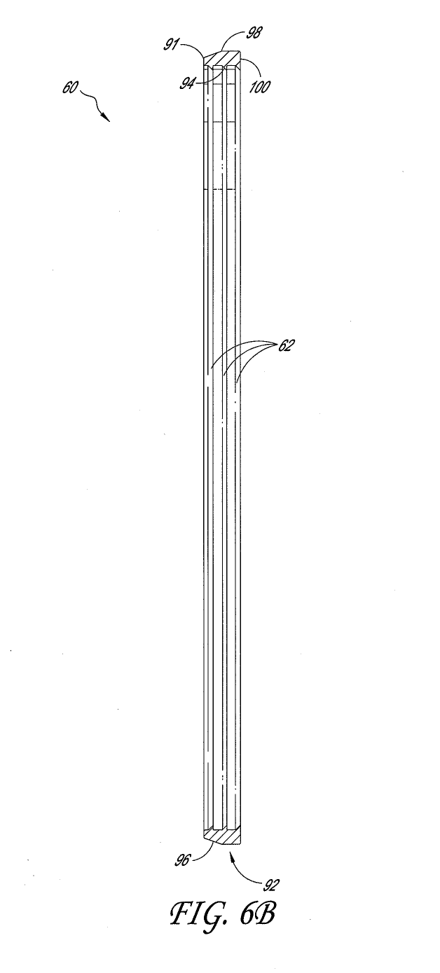

FIG. 6A is a perspective view of the restraining member 60 from FIG. 3. FIG. 6B is a cross-section view of the restraining member 60 from FIG. 6A. The restraining member 60 is received in a complimentary fashion within the groove 56 contained within the interior surface 64 of the casing 44. As shown in FIG. 9A, a tip region 91 of the restraining member 60 contacts the stop 74 on the inner surface 64 of the casing 44 to prevent the restraining member 60 from sliding out of the groove 56 and thereby assist in retaining the restraining member 60 within the casing 44. The restraining member 60 has an exterior surface 92 and an interior surface 94. The interior surface 94 has the one or more teeth or projections 62. In the illustrated embodiment shown in FIG. 6B, the restraining member 60 has three rows of teeth 62. The rows of teeth 62 on the restraining member 60 are arranged for engaging selected points on the exterior surface of the male pipe 20 while the rows of teeth 62 on the restraining member 58 are arranged for engaging selected points on the outer surface of the exterior surface of the female pipe 22. The restraining member 60 exterior surface 92 has a sloping profile 96 which contacts the upwardly sloping ramp 72 of the casing 44. Contact with the outer surface of the male pipe 20 causes the restraining member 60 to ride along the ramp 72 at an angle while the one or more teeth or projections 62 on the restraining member 60 interior surface 94 engage the exterior surface of the male pipe 20.

The one or more teeth or projections 62 on the interior surface 94 of the restraining member 60 can be of equal height as measured from the interior surface 94 or can vary in length and can be arranged in either a uniform or non-uniform pattern about the inner circumference of the restraining member 60. In the illustrated embodiment, the rows of teeth 62 have a uniform height. In certain embodiments, the rows of teeth 62 have a slightly greater height than other rows of teeth 62. The one or more teeth or projections 62 are angled away from a radial direction at an angle of less than 90 degree. In certain embodiments, the angle is 60 degrees or 45 degrees. As explained above, the angle of the one or more teeth or projections 62 inhibits longitudinal movement in one direction. Preferably, the teeth 62 of the restraining member 58 are angled towards the restraining member 60 while the teeth 62 of the restraining member 60 are angled towards the restraining member 58.

The exterior surface 92 of the restraining member 60 extends from the tip region 91 across the sloping profile 96 and reaches peak 98. The exterior surface 92 continues in a downward direction and terminates at base 100.

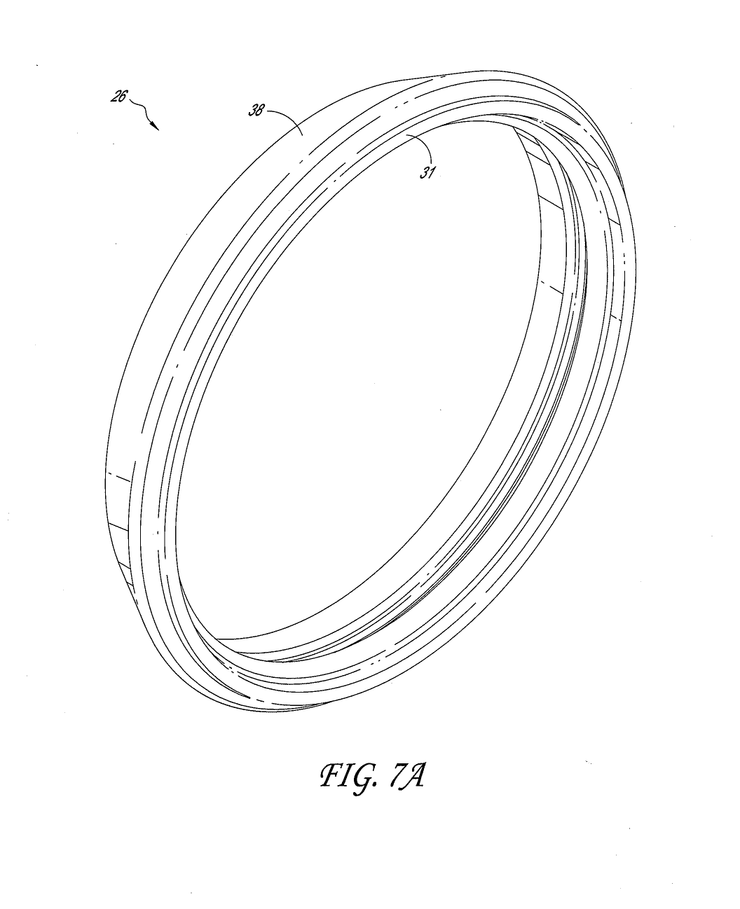

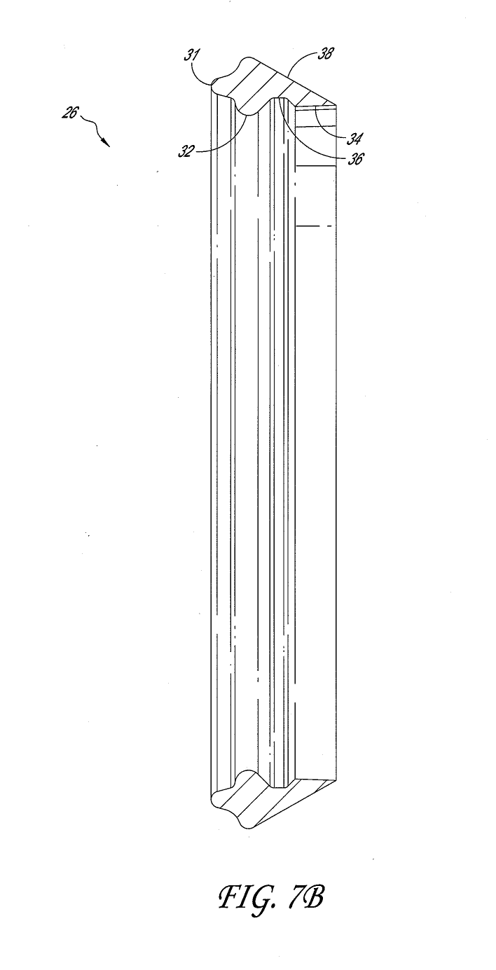

FIG. 7A is a perspective view of the seal 26 from FIG. 3. FIG. 7B is a cross-section view of the seal 26 from FIG. 7A. The seal 26 is installed within the groove 28 provided within a socket end 3Q of the female pipe section 22. The seal 26 has a low profile which allows insertion of the male, spigot pipe section 20 within the female, pipe section 22 with a minimum insertion force while maintaining the desired sealing characteristics of the pipe joint. The seal 26 is useful in diverse sealing applications, including sewer pipe and other low pressure pipe. Particularly with respect to sewer pipe, problems of infiltration are encountered as opposed to problems of exfiltration of the type encountered with many high pressure applications. The seal 26 provides the necessary sealing capacity for both sewer pipe and irrigation pipe applications.

The seal 26 can be formed of a generally homogeneous composition, such as from a suitable rubber, thermoplastic material, resilient elastomeric material, or of an elastomeric region joined to a rigid plastic region. Suitable rubbers include natural or synthetic rubber such as a “SBR” commercial grade rubber. Elastomeric materials include EPDM or nitrile rubber. The seal 26 has a leading nose region 31 which is joined to a primary sealing surface 32 which forms a seal for engaging the outer surface of the male pipe section 20 during insertion. The primary sealing surface 32 is joined to a secondary sealing surface 34 by an intermediate circumferential groove region 36. The secondary sealing surface 34 comprises a convex circumferential region.

On the opposite side of the nose region 31 is an outermost sealing surface 38. The outermost sealing surface 38 is an outwardly uniformly sloping surface. The slope of the surface 38 is selected to match the inner surface of the mating groove 28. In certain embodiments, a reinforcing element, such as metal ring, passes through the ring shaped elastomeric body at one circumferential location. Of course, any number of specialized sealing rings can be utilized in order to optimize the sealing function.

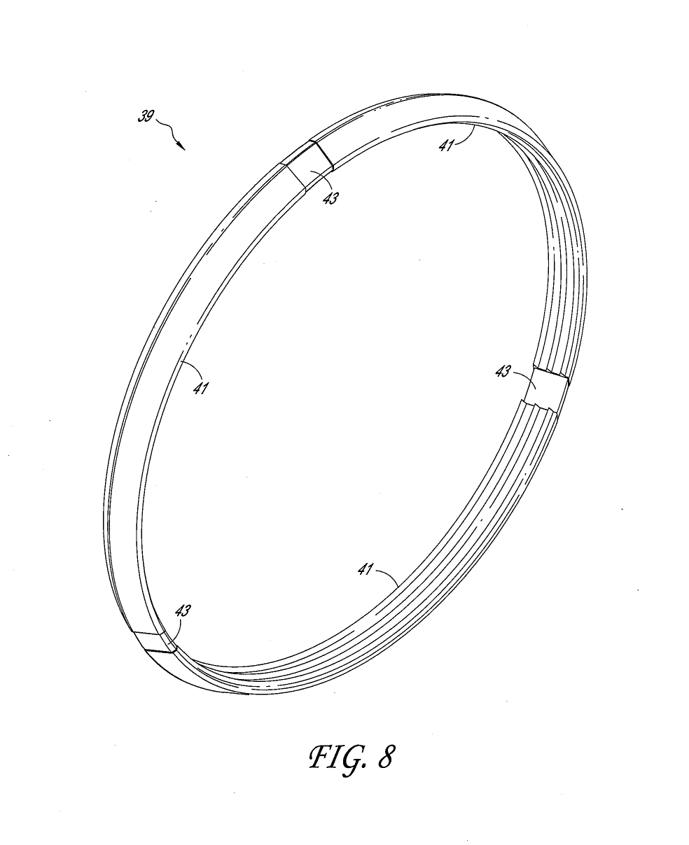

FIG. 8 is a perspective view of an alternate embodiment of a restraining member 39 that includes gripping sections 41 separated by elastomeric sections 43. As shown in FIG. 8, the restraining member 39 is formed with two or more gripping sections 41, which are typically made from a rigid material such as plain steel with corrosion-protection coating, stainless steel, brass, aluminum, or a material such as ceramic. Elastomeric sections 43 join the rigid sections 41 to form a circle. In certain embodiments, the same elastomeric material is molded to form a layer around the outer circumference of the restraining member 39. The elastomeric material used, which can be rubber or a thermoplastic elastomer, allows the restraining member 39 to be compressed so it can be snap-fit into the grooves 54, 56. It also will compensate for any variances in the outer circumference of the pipes 20, 22 during assembly of the joint. Additionally, it causes the rows of teeth 62 on the inner circumference of the restraining member 39 to press against the pipes 20, 22 after the joint is pressurized.

FIG. 9A is a cross-section view of the assembled joint from FIG. 2 showing both the spigot end of the male pipe 20 and the belled end of the female pipe 22 inside the casing 44 with the restraining members 58, 60 restraining separation of the spigot end 20 from the female pipe 22. The male pipe 20 has been inserted through the casing 44 into the socket end 30 of the female pipe 22. The seal 26 creates a seal for the joint. The rows of teeth 62 on the restraining members 58, 60 press against the outer circumference of female and male pipes 22, 20, respectively, restraining them from relative longitudinal movement after the joint is pressurized. The casing 44 can also be used to join sections of PVC pipe and fabricated and molded plastic fittings. Alternatively, the female pipe 22 and male pipe 20 with which the casing 44 is used, as well as pipe fittings, can be made from ductile iron, steel, and other rigid materials.

FIGS. 9B through 9D show one method for assembling a male pipe 20 to a female pipe 22 using the restraining system 42. Preferably, the seal 26 is already placed within the groove 28. In FIG. 9B, the belled end of the female pipe 22 has been slid into the casing 44 and the restraining member 58. As the female pipe 22 is slid into the casing 44, the one or more teeth or projections 62 on the restraining member 58 contact the outer surface of the female pipe 22. This contact causes the restraining member 58 to slide along the ramp 72 towards the abutment surface 68. The female pipe 22 slides until the distal surface 70 of the female pipe 22 contacts the abutment surface 68.

In FIG. 9C, the spigot end of the male pipe 20 is moved into the casing 44 and the restraining member 60. As the male pipe 20 is slid into the casing 44, the one or more teeth or projections 62 on the restraining member 60 contact the outer surface of the male pipe 20. This contact causes the restraining member 60 to slide along the ramp 72 towards the abutment surface 68. The male pipe 20 can slide in the female pipe 22 until the pipe 20 reaches the end of the belled region of the female pipe 22. Once the joint is assembled as illustrated in FIG. 9C, significant relative movement of the male and female pipes 20, 22 to separate the joint is inhibited by the casing 44 in combination with the restraining member 58, 60. Once assembled, movement of the male and female pipes 20, 22 to separate the joint simultaneously moves the restraining members 58, 60. The one or more teeth 62 of the restraining members 58, 60 bite into the outer surfaces of the male and female pipes 20, 22 to inhibit relative movement of the restraining member 58 with respect to the female pipe 22 and relative movement of the restraining member 60 with respect to the male pipe 20. In this way the restraining member 58 becomes locked to and moves with the female pipe 22 and the restraining member 60 becomes locked to and moves with the male pipe 20 at least in a direction away from the abutment surface 68. Movement of the restraining member 60 and male pipe 20 away from the casing 44 compresses the casing 44 around the joint due to the restraining member 60 sliding along the ramp 72. Likewise, movement of the restraining member 58 and female pipe 22 away from the casing 44 compresses the casing 44 around the joint due to the restraining member 58 sliding along the ramp 72. In this way, a gap may exist between the abutment surface 68 and the female pipe 22 as a result of the casing 44 compressing the joint. Similarly, a gap may exist between the end of the male pipe 20 and the end of the belled region of the female pipe 22. However, once the casing 44 has sufficiently compressed the male and female pipes 20, 22, further movement of the male pipe 20 and female pipes 20, 22 to separate the joint is prevented.

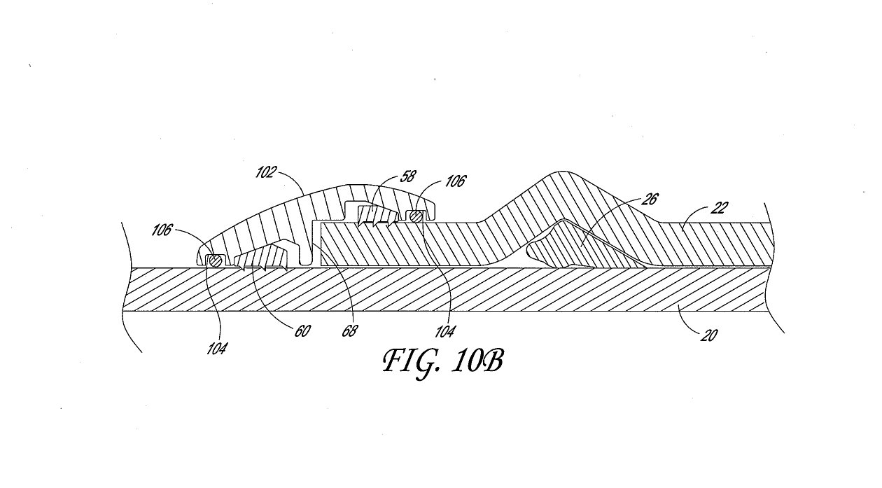

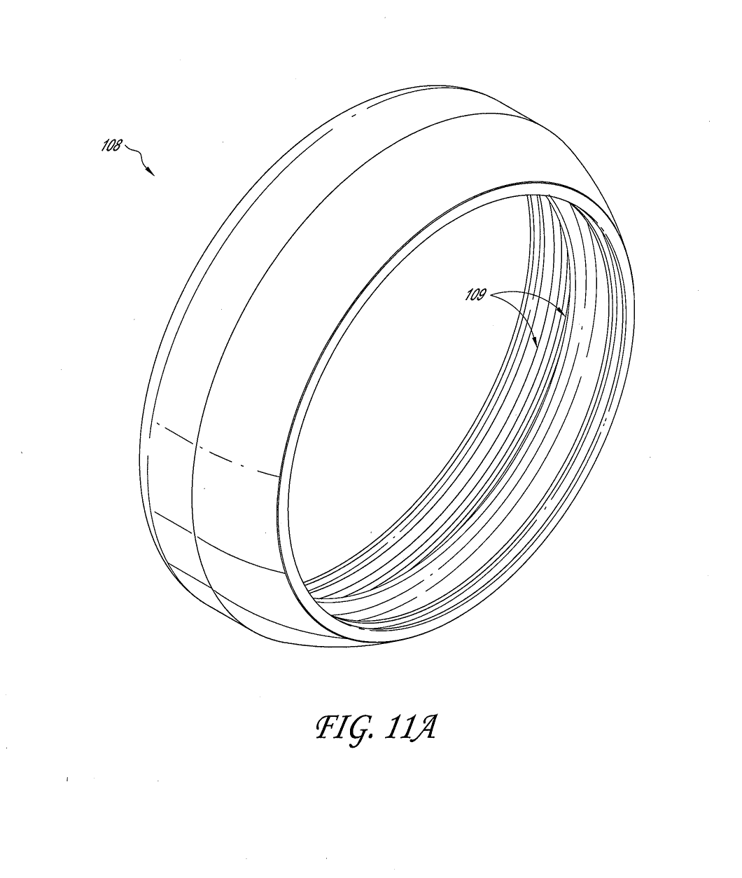

FIG. 10A is a perspective view of an alternate embodiment of a casing 102 which includes one or more channels 104 for receiving one or more O-rings 106. FIG. 10B is a cross-section view of the casing 102 from FIG. 10A. The casing 102 is similar to the casing 44 described in connection with FIGS. 4A-B except that the casing 102 also includes one or more channels 104. Thus, the description of the casing 44 set forth above applies with equal force to the embodiment illustrated in FIG. 10A. The O-rings 106 are configured to prevent the entrance of foreign material and external water into the joint.

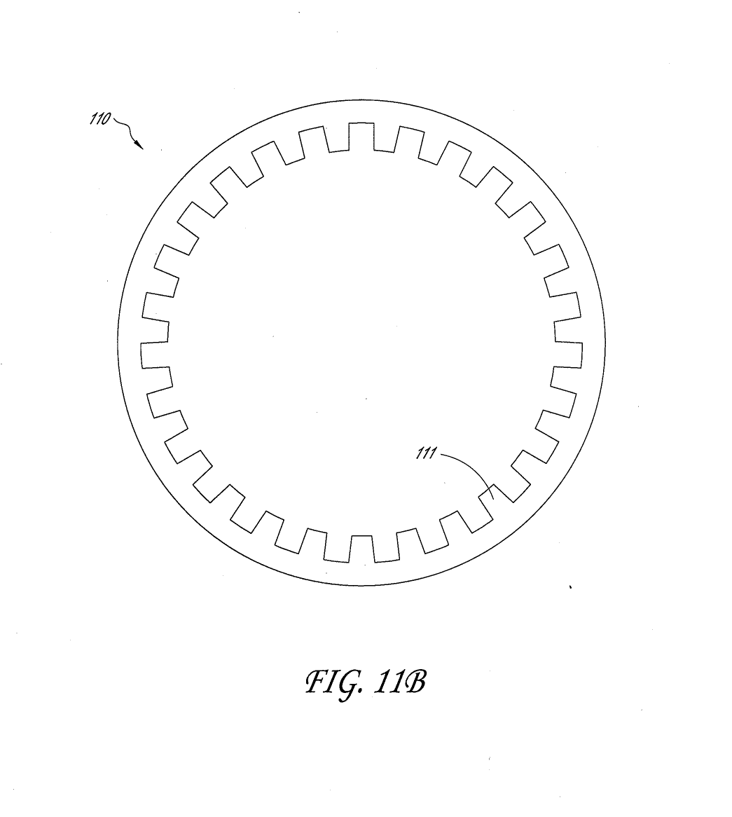

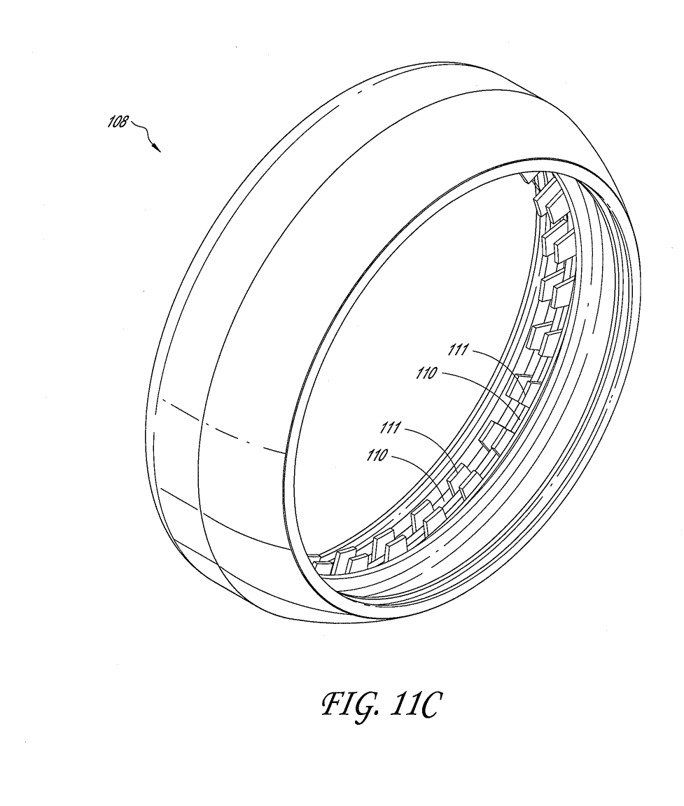

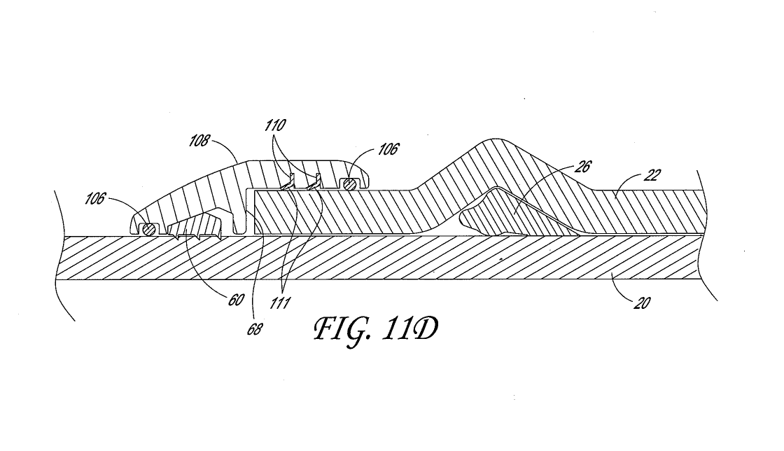

FIG. 11A is a perspective view of an alternate embodiment of a casing 108 which is used with two types of restraining member. The casing 108 includes one or more channels 109 on an inner circumference. FIG. 11B is a plan view of one of the two types of restraining member for use with the casing 108 from FIG. 11A. The restraining member 110 is preferably a thin metal ring and includes a plurality of teeth 111 extending in an inward direction. Thus, the restraining member illustrated in FIG. 11B is in the form of toothed rings 110. The casing 108 is similar to the casing 44 described in connection with FIGS. 4A-B except that the casing 108 also includes one or more channels 104 for O-rings 106 and replaces the groove 54 and restraining member 58 with one or more channels 109 and one or more toothed restraining members 110. Thus, one of the restraining members is the same as restraining member 60 illustrated in FIGS. 6A-B and the other is one or more of the restraining members 110 illustrated in FIG. 11B. Each restraining member 110 is in the form of a ring and includes one or more teeth 111. Thus, the descriptions of the casings 44, 102 and restraining member 60 set forth above apply with equal force to the embodiment illustrated in FIG. 11A at least for their common structures.

FIG. 11C is a perspective view of the casing 108 from FIG. 11A with two restraining members in the form of toothed rings 110 disposed in the one or more channels 109 on one end of the casing 108. Each of the toothed rings 110 includes one or more teeth 111 for gripping the outer surface of the female pipe 22 to inhibit movement of the casing 108. The teeth 111 advantageously increase the surface friction between the restraining member 110 and the adjacent surface. This increase in surface friction may be in one or more directions. For example, the teeth 111 can extend in a direction that is normal to the adjacent surface or canted or angled with respect to the adjacent surface. For embodiments where the teeth 111 extend normal to the adjacent surface, the increase in surface friction may be generally equal in both directions. Thus, the degree of resistance to sliding the restraining member 110 may be the same in either longitudinal direction along the outer surface of the pipe. In embodiments where the teeth 111 are canted or angled, the increase in surface friction may be greater in one direction. Thus, the degree of resistance to sliding the restraining member 110 may be greater in a direction towards the center of the casing 108 than in a direction away from the center of the casing 108. Other factors can change the degree of resistance including the degree of compression applied by the casing 108 to the restraining member 110 as well as the distribution of the compressive force across the surface of the restraining member 110.

Further, the teeth 111 may be fabricated as straight teeth 111 extending in a radially inward direction which then bend when the casing 108 is installed over the joint resulting in the teeth 111 being canted or angled after assembly of the joint. In this way, the distal ends of teeth 111 of the restraining member 110 are allowed to bend in a direction towards the center of the casing 108 during assembly. Once bent, the teeth 111 will inhibit movement of the casing 108 away from the female pipe 22.

FIG. 11D is a cross-section view of an assembled joint that includes the casing 108 from FIG. 11C. When the female pipe 22 is inserted into the casing 108, the teeth 111 of the restraining member(s) 110 will fold towards the abutment surface 68 allowing the female pipe 22 to pass into the casing 108 and contact the abutment surface 68. However, once the male pipe 20 is installed, movement of the female pipe 22 away from the abutment surface 68 is inhibited by the teeth 111 biting into the outer surface of the female pipe 22. The restraining member 60 compresses the joint as discussed above.

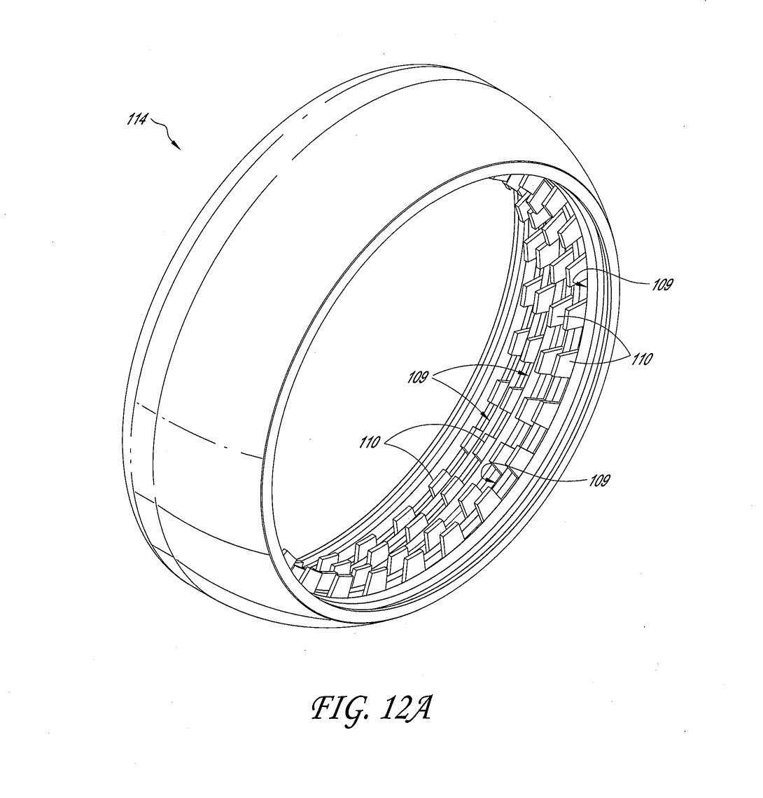

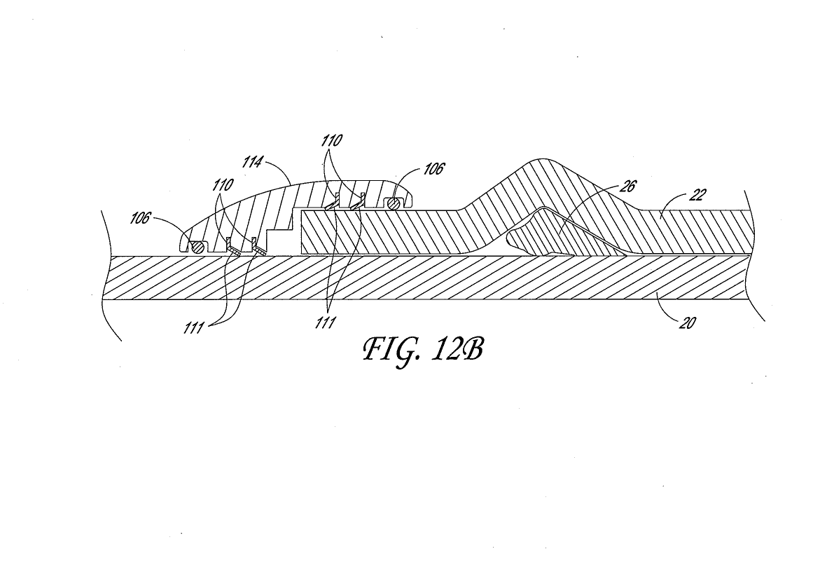

FIG. 12A is a perspective view of an alternate embodiment of a casing 114, which includes one or more channels 109 for receiving restraining members in the form of toothed rings 110 on both ends of the casing 114. FIG. 12B is a cross-section view of an assembled joint that includes the casing 114 from FIG. 12A with the toothed rings 110 on both ends of the casing 114. The one or more channels 109 are disposed on an inner circumference of the casing 114. The restraining member 110 is the same restraining member described in connection with FIG. 11B and is preferably a thin metal ring with a plurality of teeth 111 extending in an inward direction. The casing 114 is similar to the casing 108 described in connection with FIGS. 11A-D except that the casing 114 replaces the groove 56 and restraining member 60 with one or more channels 109 and one or more toothed restraining members 110. Thus, the restraining members 110 configured to contact both the male and female pipes 20, 22 are in the form of rings with each including one or more teeth 111. In this way, the descriptions of the casings 108 and restraining members 110 set forth above apply with equal force to the embodiment illustrated in FIG. 12A at least for their common structures.

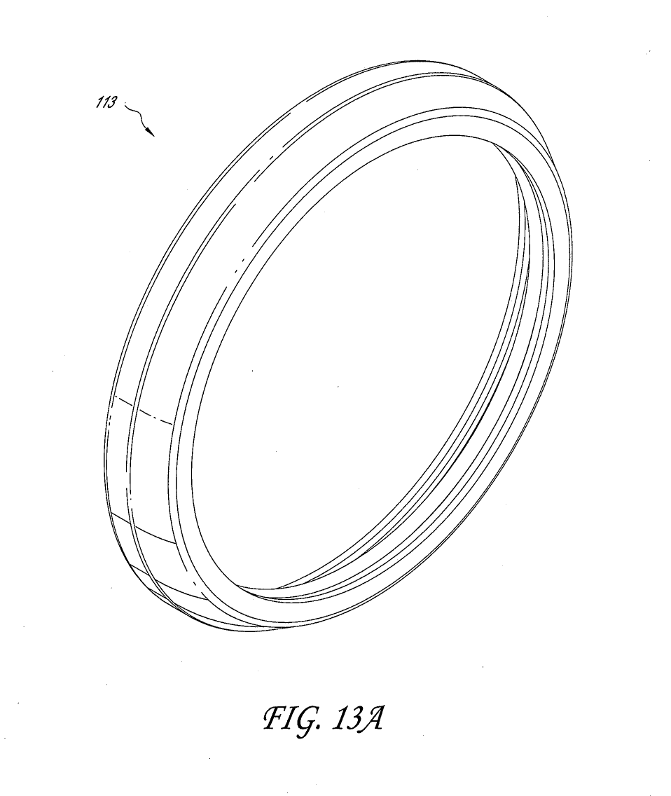

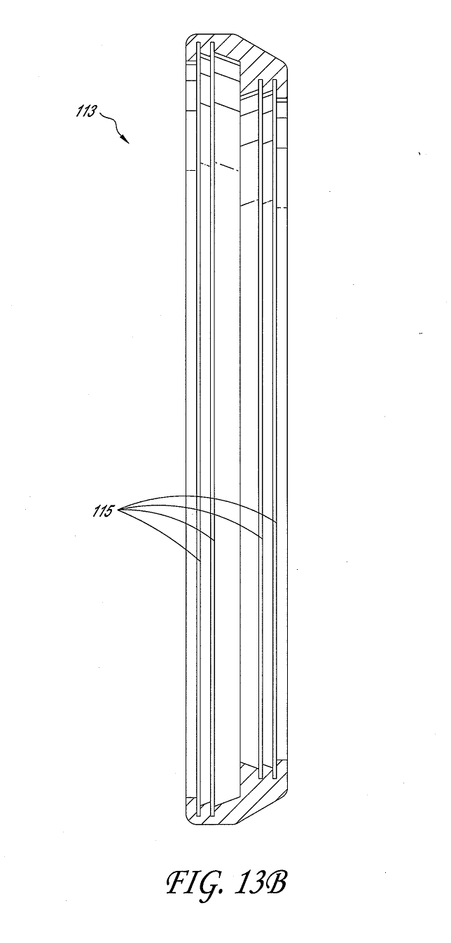

FIG. 13A is a perspective view of an alternate embodiment of a casing 113 that includes another type of restraining member 115. The restraining member 115 is preferably a thin metal ring similar to the restraining member 110 in FIG. 11B except that the restraining member 115 is formed with a curved or bent edge. The curved or bent edges are configured to contact the male and female pipes 20, 22.

FIG. 13B is a cross-section view of the casing 113 and restraining members 115 from FIG. 13A. The edge of the restraining member 115 is angled so as to contact the outer surface of the male and female pipes 20, 22 and inhibit movement of the casing 113 relative to the contacted pipe 20, 22 in one direction more than in another direction. For example, in certain embodiments the edge is biased so as to inhibit movement male and female pipes 20, 22 in a direction away from the center of the casing 113.

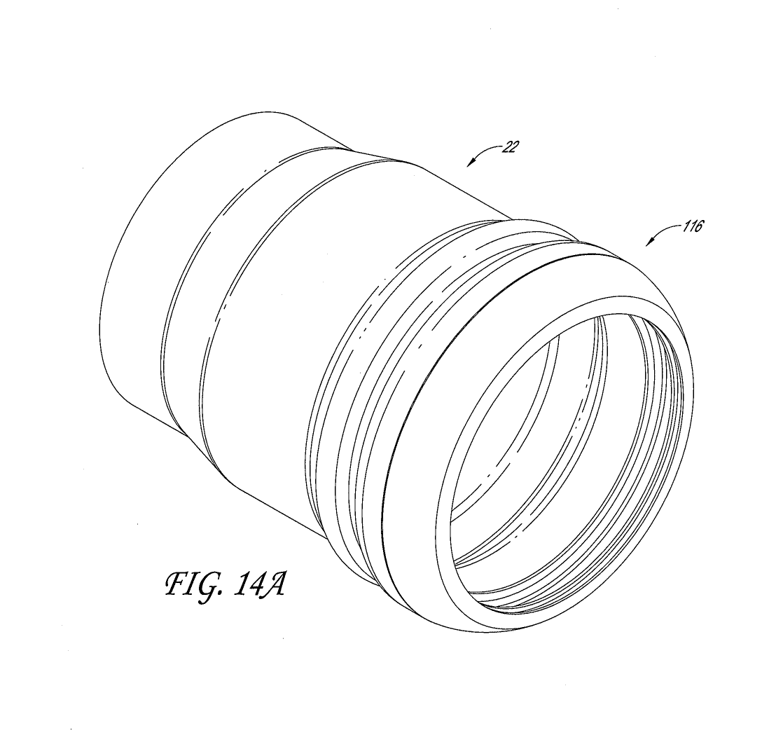

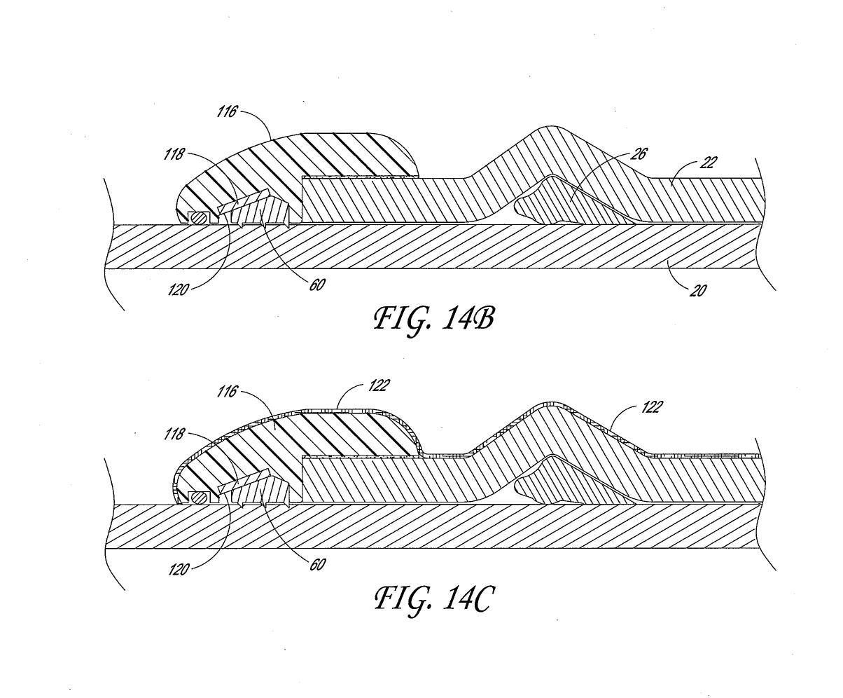

FIG. 14A is a perspective view of an alternate embodiment of a casing 116, which has been adhered to the outer surface of the female pipe 22 and includes a restraining member 60 for gripping against the outer surface of the male pipe 20. FIG. 14B is a cross-section view of an assembled joint that includes the casing 116 from FIG. 14A. The casing 116 can be made from polyvinyl chloride (PVC), ceramic, composite, or a similar material and is solvent welded to the outer surface of the female pipe 22. In this way, a portion of the casing 116 has been fused or solvent welded onto the outer diameter of the female pipe 22.

A restraining member 60, as described above, is disposed within a groove 120 of the casing 116. The groove 120 is similar to the groove 56 illustrated in FIG. 2 except that a metal insert 118 is disposed in the bottom of the groove 120. In this way, the restraining member 60 slides against a metal surface even when the casing 116 is made of a plastic, such as PVC. The male pipe 20 is inserted into the casing 116 and the restraining member 60. The male pipe 20 is further inserted into the belled end of the female pipe 22.

When the casing 116 will be used with metal pipe, the casing 116 is fabricated from a material such as steel with a corrosion-protection coating, stainless steel, brass, or aluminum. At least a portion of the casing 116 is welded onto the outer diameter of the female pipe 22. In either event, the restraining member 60 is the same as the one described in FIGS. 6A-B, supra. After the spigot pipe 20 has been inserted into the female pipe 22, the joint will be pressurized, causing the rows of teeth 62 on the inner circumference of the restraining member 60 to press against the spigot pipe 20.

FIG. 14C is a cross-section view of the assembled joint from FIG. 14B with a wrap 122 disposed around the outer circumference of the assembled joint. The wrap material may be selected from materials including composites or other similar materials. The wrap 122 advantageously reinforces the adherence between the casing 116 and the lip of the female pipe 22. The wrap 122 may further inhibit the entrance of foreign material and external water into the joint.

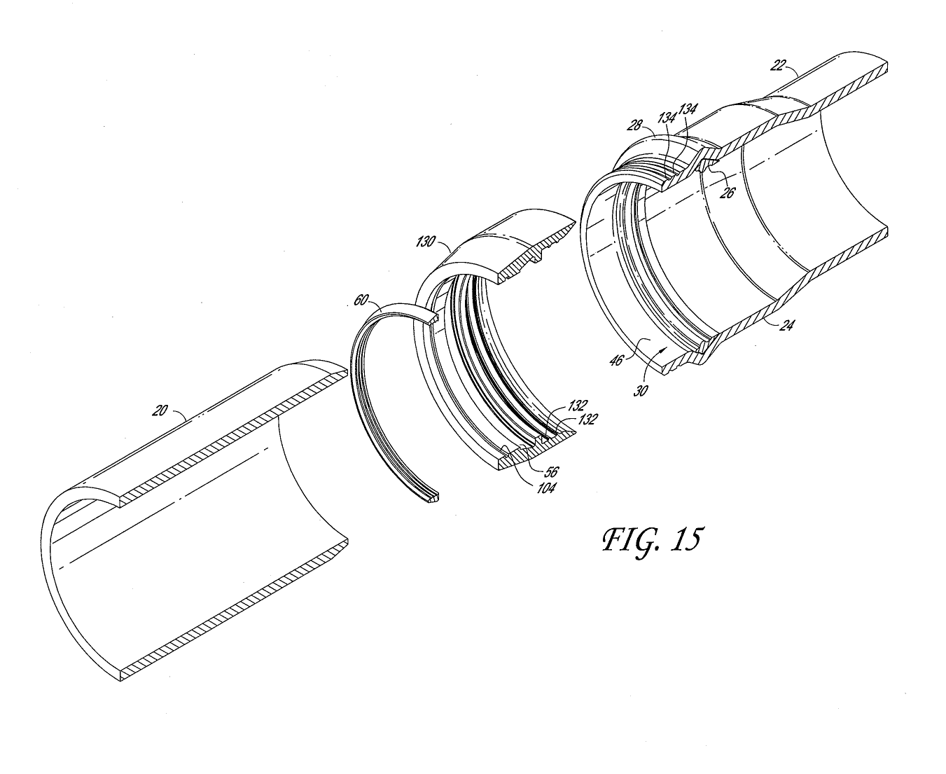

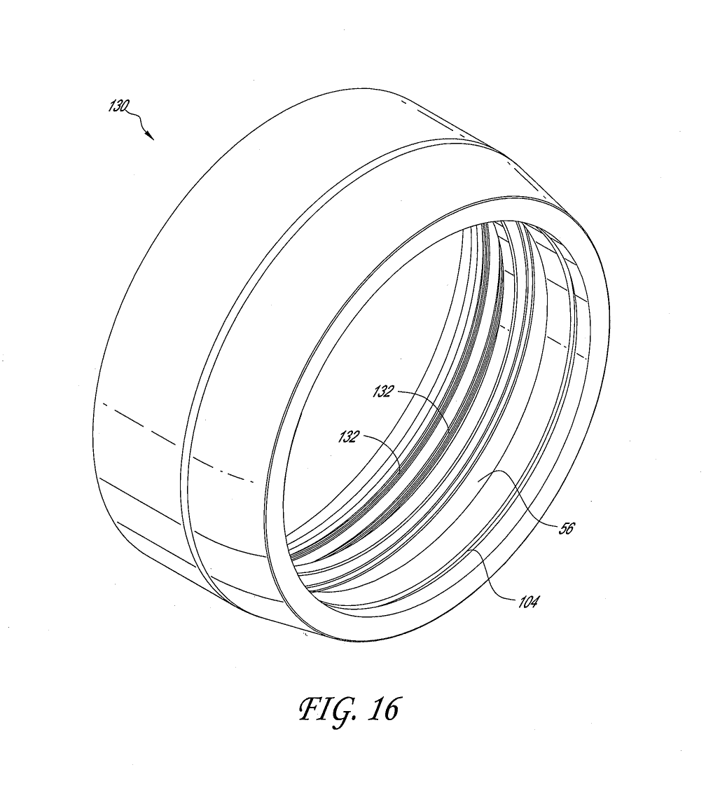

FIG. 15 is a perspective view, broken away, of male and female pipe sections 20, 22 about to form a pipe coupling utilizing an alternate embodiment of a casing 130. The female pipe section 22 includes one or more slots 134 for engaging with the casing 130. The female pipe 22 further includes belled end 24 with a sealing ring 26 in place within a mating groove 28. The groove 28 is in a socket end 30 of the female pipe section 22 adjacent to lip 46.

The casing 130 can be made from any of a number of materials, including steel with a corrosion-protection coating, stainless steel, brass, aluminum, polyvinyl chloride (PVC) or other rigid plastic material, or a composite material. The casing 130 comprises groove 56. The groove 56 extends along at least a portion of the inner circumference of the casing 130 and is sized and shaped to receive a restraining member 60. In the illustrated embodiment, the groove 56 and the restraining member 60 extend about the entire circumference of the casing 130. Of course the groove 56 and the restraining member 60 need not extend about the entire circumference of the casing 130. The casing 130 may further include one or more ridges 132 and one or more channels 104 for receiving one or more O-rings 106.

The one or more ridges 132 can be in the form of a raised surface on the inside of the casing 130 or in the form of a screw thread. In embodiments where the one or more ridges 132 are in the form of a screw thread, the one or more slots 134 in the female pipe section 22 can be in the form of a mating screw thread configured to engage with the casing 130 by screwing the casing 130 onto the female pipe section 22.

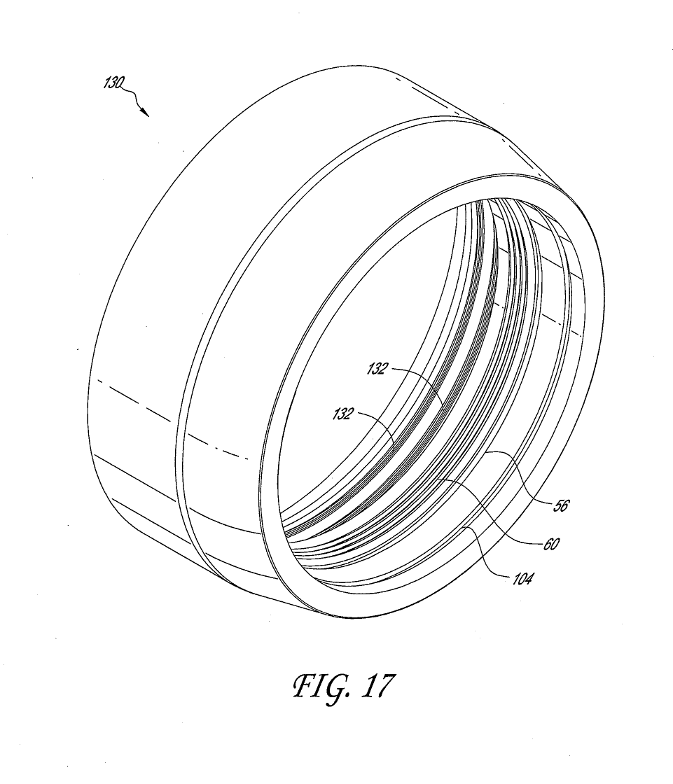

FIG. 16 is a perspective view of the casing 130 from FIG. 15. FIG. 17 is a perspective view of the casing 130 from FIG. 16 showing the one or more ridges 132 on one end of the casing 130. The one or more ridges 132 engage with the one or more slots 134 in the female pipe section 22. The one or more ridges 132 are disposed on an inner circumference of the casing 130.

The casing 130 is similar to the casing 44 described in connection with FIGS. 4A-B except that the casing 130 also includes one or more channels 104 for O-rings 106 and replaces the groove 54 and restraining member 58 with one or more ridges 132 for engaging with the one or more slots 134 in the female pipe section 22. The restraining member 60 is the same restraining member described in connection with FIG. 6A. Thus, one of the restraining members is the same as restraining member 60 illustrated in FIGS. 6A-B and the other is the one or more ridges 132.

At least a portion of the one or more ridges 132 are sized and shaped to fit within at least a portion of the one or more slots 134 in the female pipe section 22. In this way, the one or more slots 134 will inhibit movement of the casing 130 relative to the female pipe section 22. Thus, the descriptions of the casings 44, 102 and restraining member 60 set forth above apply with equal force to the embodiment illustrated in FIG. 15 at least for their common structures.

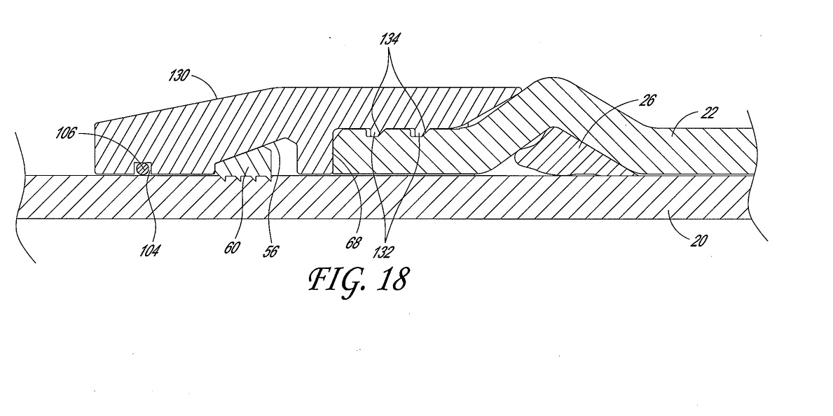

FIG. 18 is a cross-section view of an assembled joint that includes the casing 130 from FIG. 17. When the female pipe 22 is inserted into the casing 130, at least a portion of the one or more ridges 132 on the casing 130 and/or the lip 46 of the female pipe section 22 will elastically deform to allow the one or more ridges 132 to engage with the one or more slots 134. In embodiments where the one or more ridges 132 and/or the one or more slots 134 are in the form of screw threads, the female pipe 22 and the casing 130 are rotated relative to each other to assemble the joint.

Further movement of the female pipe section 22 into the casing 130 is inhibited by the lip 46 contacting the abutment surface 68 and/or the casing 130 contacting the outside of the groove 28 formed in the female pipe section 22. Movement of the female pipe 22 away from the abutment surface 68 is inhibited by the engagement between the one or more ridges 132 and the one or more slots 134.

When the male pipe 20 is inserted into the casing 130, the restraining member 60 slides in a longitudinal direction across the outer surfaces of the male pipe 20 to wedge or lock between the casing 130 and the male pipe 20. Once wedged, the compression of the restraining member 60 around the male pipe 20 by the casing 130 prevents further movement of the male pipe 20 away from the female pipe 22 that would degrade the function of the seal 26.

The information in the disclosure and description of the invention itself are illustrative only of the application of the principles of the present invention. For example, the restraining member described herein can be installed onto the ends of pipe fittings in the same manner as described for its installation onto the ends of lengths of female pipe. Other modifications and alternative embodiments may be devised by those skilled in the art without departing from the spirit and scope of the present invention.

Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Furthermore, the skilled artisan will recognize the interchangeability of different embodiments. For example, various restraining members and casings disclosed herein, as well as other known equivalents for each such feature, can be mixed and matched by one of ordinary skill in this art to construct restraining systems in accordance with principles of the present invention.

Although this invention has been disclosed in the context of certain preferred embodiments and examples, it therefore will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims.

What is claimed is:

1. A restraining system for securing a female pipe to a mating male pipe, the female pipe having a distal surface, the system comprising:
a ring-shaped casing having an interior surface and an exterior surface, the interior surface having a plurality of circumferential grooves separated by an abutment surface, the abutment surface being configured to contact the distal surface of the female pipe at least when the casing is slid over the female pipe;
a first restraining ring having a first diameter and being configured to be disposed in one of the plurality of grooves so as to contact both the casing and the female pipe;
a second restraining ring having a second diameter and being configured to be disposed in another one of the plurality of grooves so as to contact the casing and the male pipe, the second diameter being less than the first diameter; and
a sealing ring disposed between portions of the male and female pipes.

2. The restraining system as in claim 1, wherein at least one of the first and second restraining rings has an interior surface and an exterior surface, the interior surface comprising one or more rows of teeth, the one or more rows of teeth being disposed on the restraining ring so as to contact one of the male and female pipes.

3. The restraining system as in claim 1, wherein the female pipe has an interior surface, the interior surface having a groove sized and shaped to receive a ring-shaped seal member.

4. The restraining system as in claim 1, wherein at least a portion of the plurality of circumferential grooves has a generally triangular cross-sectional shape.

5. The restraining system as in claim 1, wherein at least one of the first and second restraining rings comprises at least one metal segment and at least one elastomeric segment, the elastomeric segment being disposed between ends of the at least one metal segment.

6. The restraining system as in claim 1 further comprising an O-ring, the O-ring being disposed in one of the plurality of circumferential grooves in the casing.

7. The restraining system as in claim 6, wherein the first restraining ring is disposed between the O-ring and the abutment surface along a longitudinal axis.

8. The restraining system as in claim 1, wherein the casing comprises one of bronze, brass, aluminum, cast steel, and plastic.

9. The restraining system as in claim 1, wherein the first restraining ring comprises stainless steel.

10. The restraining system as in claim 1, wherein at least one of the first and second restraining rings comprises a plurality of radial slits extending partially therethrough to define a plurality of flexible teeth, the plurality of flexible teeth being disposed so as to permit relative movement of the male and female pipes in a direction towards each other while preventing relative movement of the male and female pipes in a direction away from each other.

11. A restraining system for securing a female plastic pipe to a mating male plastic pipe, the female plastic pipe having a distal surface, the system comprising:
a ring-shaped casing having an interior surface and an exterior surface, the interior surface having at least one circumferential groove and an abutment surface, at least a portion of the interior surface being disposed so as to be adhered to an outer surface of the female plastic pipe, the abutment surface being configured to contact the distal surface of the female plastic pipe at least when the casing is slid over the female plastic pipe; and
a restraining member being configured to be disposed in the at least one circumferential groove so as to contact both the casing and the male plastic pipe.

12. The restraining system as in claim 11, wherein the casing comprises PVC.

13. The restraining system as in claim 11, wherein the casing comprises a metal insert.

14. The restraining system as in claim 11 further comprising an O-ring, the O-ring being disposed in one of the plurality of circumferential grooves in the casing.

15. The restraining system as in claim 11 further comprising a reinforcing cloth in contact with the exterior surface of the casing.

16. A restraining system for permitting relative movement of male and female plastic pipes in a longitudinal direction towards each other during assembly while inhibiting relative movement of the male and female plastic pipes in a direction away from each other to prevent separation, the system comprising:
a ring-shaped casing having an interior surface, the interior surface having a plurality of grooves;
a first restraining member having a first inner diameter and being configured to be disposed in one of the plurality of grooves so as to contact both the inner surface of the casing and the female plastic pipe; and
a second restraining member having a second inner diameter and being configured to be disposed in another one of the plurality of grooves so as to contact the inner surface of the casing and the male plastic pipe, the second inner diameter being less than the first inner diameter.

17. The restraining system as in claim 16, wherein the first restraining member has a continuous ring shape.

18. The restraining system as in claim 16, wherein each of the plurality of grooves extends along at least a portion of an inner circumference of the casing.

19. The restraining system as in claim 16, wherein the first restraining member comprises a plurality of segments, and wherein the segments are spaced apart in one of the plurality of grooves.

20. The restraining system as in claim 19 wherein the first restraining member further comprises at least one elastomeric segment, the elastomeric segment being disposed between ends of the plurality of segments.

21. The restraining system as in claim 16, wherein at least one of the plurality of grooves has a sloping profile which matches at least a portion of an outer profile of the first restraining member so that movement of the first restraining member in a longitudinal direction away from the second restraining member relative to the casing causes the first restraining member to wedge between the female plastic pipe and the casing.

22. The restraining system as in claim 16, wherein the casing is formed of a material selected from the group consisting of metals, composites and rigid elastomers or plastics.

23. The restraining system as in claim 16 further comprising a sealing ring disposed between portions of the male and female plastic pipes, wherein the sealing ring is formed from a material selected from the group consisting of natural and synthetic rubbers and elastomers, polymeric plastics and composites.

24. A restraining system for securing a female plastic pipe to a mating male plastic pipe, the female plastic pipe having an outer surface with one or more slots and a distal surface, the system comprising:
a ring-shaped casing having an interior surface and an exterior surface, the interior surface having at least one circumferential groove, one or more ridges, and an abutment surface disposed therebetween, the one or more ridges being disposed so as to engage with the one or more slots in the female plastic pipe, the abutment surface being configured to contact the distal surface of the female plastic pipe at least when the casing is slid over the female plastic pipe; and
a restraining member being configured to be disposed in the at least one circumferential groove so as to contact both the casing and the male plastic pipe.

25. The restraining system as in claim 24, wherein the casing comprises PVC.

26. The restraining system as in claim 24, wherein the casing comprises a metal insert.

27. The restraining system as in claim 24 further comprising an O-ring, the O-ring being disposed in one of the plurality of circumferential grooves in the casing.
